(19) United States
(12) Patent Application Publication
(10) Pub. No.: US 2023/0354900 A1
(43) Pub. Date: Nov. 9, 2023

(54) AEROSOL PROVISION DEVICE

(71) Applicant: Nicoventures Trading Limited, LONDON (GB)

(72) Inventors: Michael THOMAS, London (GB); Matthew HOLDEN, London (GB); Conor MCGRATH, London (GB); Jonathan BURGESS, London (GB)

(21) Appl. No.: 18/245,595

(22) PCT Filed: Sep. 15, 2021
(86) PCT No.: PCT/EP2021/075367

§ 371 Date: Mar. 16, 2023

(30) Foreign Application Priority Data
Sep. 16, 2020 (GB) 2014599.1

(51) Int. Cl. A24F 40/465; A24F 40/90; A24F 40/50

(52) U.S. Cl. CPC A24F 40/465; A24F 40/90; A24F 40/50

(57) ABSTRACT

An aerosol provision device is described. The device comprises an aerosol generating assembly, an electrical component, which may be a printed circuit board (PCB) and a chassis holding the electrical component and the aerosol generating assembly. The aerosol generating assembly has: a heater assembly to receive aerosol generating material. The heater assembly has a susceptor which is heatable by penetration with a varying magnetic field; and an inductor coil extending around the heater assembly. The inductor coil generates the varying magnetic field. The inductor coil has a coil wire end engaged with the electrical component. The chassis has a coil end positioning arrangement to hold and align the coil wire end with the electrical component. The chassis itself is also described herein.

### PRIORITY CLAIM

The present application is a National Phase entry of PCT Application No. PCT/EP2021/075367, filed Sep. 15, 2021, which claims priority from GB Application No. 2014599.1, filed Sep. 16, 2020, each of which hereby fully incorporated herein by reference.

### TECHNICAL FIELD

The present invention relates to an aerosol provision device and a chassis for an aerosol provision device.

### BACKGROUND

Smoking articles such as cigarettes, cigars and the like burn tobacco during use to create tobacco smoke. Attempts have been made to provide alternatives to these articles that burn tobacco by creating products that release compounds without burning. Examples of such products are heating devices which release compounds by heating, but not burning, the material. The material may be for example tobacco or other non-tobacco products, which may or may not contain nicotine.

### SUMMARY

According to an aspect of the present disclosure, there is provided an aerosol provision device, the device comprising: an aerosol generating assembly; an electrical component, and a chassis holding the aerosol generating assembly and the electrical component; the aerosol generating assembly having: a heater assembly configured to receive aerosol generating material, wherein the heater assembly comprises a susceptor which is heatable by penetration with a varying magnetic field; and an inductor coil extending around the heater assembly wherein the inductor coil is configured to generate the varying magnetic field; wherein the inductor coil comprises a coil wire end engaged with the electrical component; and wherein the chassis comprises a coil wire end positioning arrangement configured to hold and align the coil wire end with respect to the electrical component.

In some embodiments, the electrical component is a printed circuit board (PCB).

The coil wire end may be a first end of the inductor coil, and the inductor coil may comprise a second end.

In some examples, the coil wire end positioning arrangement may have a first positioning means that is configured to provide said first end of said inductor coil in a first position and a second positioning means that is configured to provide said second end of said inductor coil in a second position.

In some examples, the device only comprises one inductor coil. In other examples, the device may comprise two or more inductor coils and the inductor coil mentioned above may therefore be referred to as a first inductor coil.

The aerosol provision device may further comprise a second inductor coil extending around the coil support. The second inductor coil may comprises a second coil wire with first and second coil wire ends engaged with the electrical component. The positioning arrangement may be configured to provide (and/or hold and align) the first and second coil wire ends of the second inductor coil with the electrical component.

The coil wire end positioning arrangement may have a third positioning means that is configured to provide said first end of said second inductor coil in a third position and a fourth positioning means that is configured to provide said second end of said second inductor coil in a fourth position.

In examples where more than two coil wires are provided, the positioning arrangement may comprise a plurality of positioning means.

In some examples, the positioning arrangement is further configured to hold the coil wire ends in said first, second, third and fourth (or any other plurality of) positions. In some embodiments, the first and second positions may not be axially aligned with each other.

In other embodiments the first and second positions may be axially aligned with each other.

In some embodiments the third and fourth positions may not be axially aligned with each other.

In other embodiments the third and fourth positions may be axially aligned with each other.

In some embodiments, the first and third positions may be aligned on a first axis and the second and fourth positions may be aligned on a second axis. The first and second axes are different to each other. They may also extend in a direction parallel to the longitudinal axis of the device.

In some embodiments the first, second, third and fourth positions are axially aligned with each other.

The aerosol provision device may further comprise a battery and a battery connector, said battery connector being configured to receive a cable to charge said battery of the device, and the battery connector may be positioned on said electrical component, e.g. PCB so that is axially aligned with said first, second, third and fourth positions.

In some embodiments, each of said positioning means may comprise an alignment tab protruding from said chassis, said alignment tab having a through-hole provided therethrough sized and shaped for receiving said coil wire end.

The alignment tab or tabs may extend inwardly from said chassis and in a direction parallel to said electrical component (which may be a PCB). The through-hole may extend in a direction perpendicular to the electrical component.

According to a second aspect of the present disclosure, there is provided a chassis for an aerosol provision device, the chassis comprising: an electrical component mount; an aerosol generating assembly mount, and an inductor coil wire end positioning arrangement configured to hold and align first and second wire ends of an inductor coil of an aerosol generating assembly mountable on the chassis with respect to an electrical component being mountable on the chassis.

In some embodiments, the electrical component is a printed circuit board, “PCB”.

The inductor coil wire end positioning arrangement may have a first positioning means that is configured to provide said first inductor coil wire end in a first position and a second positioning means that is configured to hold said second inductor coil wire end in a second position. This may be achieved by providing the first positioning means on the chassis at said first position and providing the second positioning means on the chassis at said second position. This may also be achieved in other ways.

The coil wire end positioning arrangement may further comprise a third positioning means that is configured to provide, and/or hold, a third inductor coil wire end of an inductor coil wire in a third position and a fourth inductor coil wire end of an inductor coil wire in a fourth position. This may be achieved by providing the third positioning means on the chassis at said third position and providing the fourth holding means on the chassis at said fourth position. This may also be achieved in other ways.

In some embodiments the first and second positions may not be axially aligned with each other. In other embodiments the first and second positions may be axially aligned with each other.

In some embodiments, the third and fourth positions may not be axially aligned with each other. In other embodiments the third and fourth positions may be axially aligned with each other.

In some embodiments, the first and third positions may be aligned on a first axis and the second and fourth positions may be aligned on a second axis. The first and second axes are different to each other. They may also extend in a direction parallel to the longitudinal axis of the device.

In some embodiments the first, second, third and fourth positions may be axially aligned with each other. The chassis may further comprise a battery and a battery connector, said battery connector being configured to receive a cable to charge said battery of the device, and wherein said battery connector is positioned on said electronic component, e.g. PCB so that is axially aligned with said first, second, third and fourth positions.

In some embodiments, each of said positioning means may comprise an alignment tab protruding from said chassis, said alignment tab having a through-hole provided therethrough sized and shaped for receiving said coil wire end. The alignment tab may extend inwardly from said chassis and in a direction parallel to said electrical component, or PCB. The through-hole may extend in a direction perpendicular to the electrical component. Although protrusions with alignment tabs having through-holes are described with the examples described herein, the device and chassis described herein are not limited to this and other means for holding coil wire ends in position relative to each other and/or relative to an electrical component are envisaged.

The coil support may be a tubular member.

The coil support may be an insulating member.

The aerosol provision device may comprise an insulating layer extending around the susceptor, between the susceptor and the coil support.

The coil support may act as a barrier.

The aerosol provision device may comprise an electromagnetic shield extending around the coil support. The electromagnetic shield may be a ferrite shield. The electromagnetic shield may abut the coil support.

The coil support may support the electromagnetic shield.

The electromagnetic shield may be adhered to the coil support.

The inductor coil may be enclosed by the coil support and the electromagnetic shield.

The inductor coil or coils may be enclosed by the coil support and the electromagnetic shield.

The coil support may be a one piece construction.

The aerosol provision device may comprise a first end support member at one end of the susceptor and a second end support member at the second end of the susceptor, wherein the coil support extends between the first end support member and the second end support member.

The aerosol provision device may comprise a thermocouple mount adjacent to a locating feature. The thermocouple mount may comprise at least one of a planar locating face, a recess, and a clip.

In use, the inductor coil may be configured to heat the susceptor to a temperature of between about 200 and about 300° C. In use, the inductor coil may be configured to heat the susceptor to a temperature of about 350° C.

The inductor coil may be substantially helical. The inductor coil may follow a helical path or a non-helical path. The inductor coil may follow a spiral path. For example, the inductor coil may be formed from wire, such as Litz wire, which is wound helically around the coil support. Other wires are anticipated. For example, the wire may be a solid wire.

Reference to an axial position means the position relative to the longitudinal axis of the device.

Reference to the “thickness” of an entity means the average distance between the inner surface of the entity and the outer surface of the entity. Thickness may be measured in a direction perpendicular to the axis of the inductor coil or coils.

The inductor coil(s), the susceptor and the insulating member may be coaxial.

In some examples, in use, the inductor coil is configured to heat the susceptor to a temperature of between about 200° C. and about 350° C., such as between about 240° C. and about 300° C., or between about 250° C. and about 280° C. When the outer cover is spaced apart from the susceptor by at least this distance, the temperature of the outer cover remains at a safe level, such as less than about 60° C., less than about 50° C., or less than about 48° C., or less than about 43° C.

One or more of the chassis, coil support, barrier member, first end support and second end support may be constructed from any insulating material, such as plastic for example. In a particular example, the coil support is constructed from polyether ether ketone (PEEK). PEEK has good insulating properties and is well suited for use in an aerosol provision device.

In another example, the coil support, barrier member, first end support and second end support may comprise mica or mica-glass ceramic.

The aerosol provision device may be a tobacco heating device, also known as a heat-not-burn device.

Further features and advantages of the invention will become apparent from the following description of preferred embodiments of the invention, given by way of example only, which is made with reference to the accompanying drawings.

### BRIEF DESCRIPTION OF THE DRAWINGS

FIG. 1 shows a front view of an example of an aerosol provision device;

FIG. 2 shows a partially exploded side view of the aerosol provision device of FIG. 1 showing a chassis, PCB, end members, power source, aerosol generating assembly, replaceable article, and outer cover;

FIG. 3 shows a close up cross-sectional side view of part of the aerosol provision device of FIG. 1;

FIG. 4 is a close up cross sectional view showing part of the aerosol generating assembly of FIG. 2;

FIG. 5 is another close up cross sectional view showing a proximal part of the aerosol generating assembly of FIG. 2;

FIG. 6 is another close up cross sectional view showing a distal part of the aerosol generating assembly of FIG. 2;

FIG. 7 is another close up cross sectional view showing part of the aerosol generating assembly of FIG. 2;

FIG. 8 is another close up cross sectional view showing part of the aerosol generating assembly of FIG. 2;

FIG. 9 shows a side view of the aerosol generating assembly of FIG. 2 including inductor coils and a coil support;

FIG. 10 shows a side view of the coil support of FIG. 9;

FIG. 11 is a side view of the chassis and aerosol generating assembly of FIG. 2; and

FIG. 12 is a close up side view of part of the coil support of FIG. 4 showing a thermocouple mount.

FIG. 13 shows a perspective view of the chassis of the device described herein.

FIG. 14 shows a perspective view of the chassis of FIG. 13 with the first and second inductor coils provided therein, with the respective coil ends being positioned in the positioning arrangement.

FIG. 15a shows the PCB when positioned within the chassis with first and second inductor coils connected to the PCB in a first arrangement.

FIG. 15b shows a side view of the first and second inductor coils that are connected to the PCB as shown in FIG. 15a.

FIG. 16a shows the PCB when positioned within the chassis with first and second inductor coils connected to the PCB in a second arrangement.

FIG. 16b shows a side view of the first and second inductor coils that are connected to the PCB as shown in FIG. 16a.

### DETAILED DESCRIPTION

As used herein, the term “aerosol generating material” includes materials that provide volatilized components upon heating, typically in the form of an aerosol. Aerosol generating material includes any tobacco-containing material and may, for example, include one or more of tobacco, tobacco derivatives, expanded tobacco, reconstituted tobacco or tobacco substitutes. Aerosol generating material also may include other, non-tobacco, products, which, depending on the product, may or may not contain nicotine. Aerosol generating material may for example be in the form of a solid, a liquid, a gel, a wax or the like. Aerosol generating material may for example also be a combination or a blend of materials. Aerosol generating material may also be known as “smokable material”.

Apparatus is known that heats aerosol generating material to volatilize at least one component of the aerosol generating material, typically to form an aerosol which can be inhaled, without burning or combusting the aerosol generating material. Such apparatus is sometimes described as an “aerosol generating device”, an “aerosol provision device”, a “heat-not-burn device”, a “tobacco heating product device” or a “tobacco heating device” or similar. Similarly, there are also so-called e-cigarette devices, which typically vaporize an aerosol generating material in the form of a liquid, which may or may not contain nicotine. The aerosol generating material may be in the form of or be provided as part of a rod, cartridge or cassette or the like which can be inserted into the apparatus. A heater for heating and volatilizing the aerosol generating material may be provided as a “permanent” part of the apparatus.

An aerosol provision device can receive an article comprising aerosol generating material for heating. An “article” in this context is a component that includes or contains in use the aerosol generating material, which is heated to volatilize the aerosol generating material, and optionally other components in use. A user may insert the article into the aerosol provision device before it is heated to produce an aerosol, which the user subsequently inhales. The article may be, for example, of a predetermined or specific size that is configured to be placed within a heating chamber of the device which is sized to receive the article.

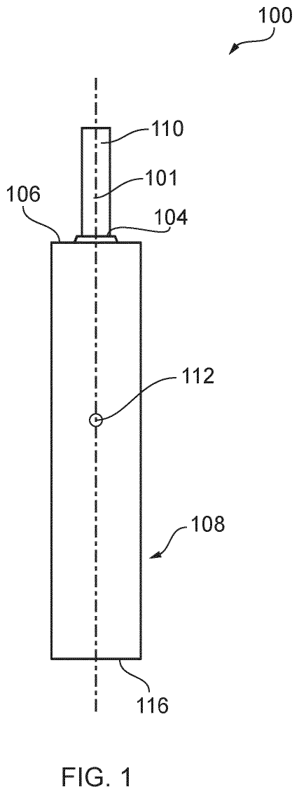

FIG. 1 shows an example of an aerosol provision device 100 for generating aerosol from an aerosol generating medium/material. In broad outline, the device 100 may be used to heat a replaceable article 110 comprising the aerosol generating medium, to generate an aerosol or other inhalable medium which is inhaled by a user of the device 100.

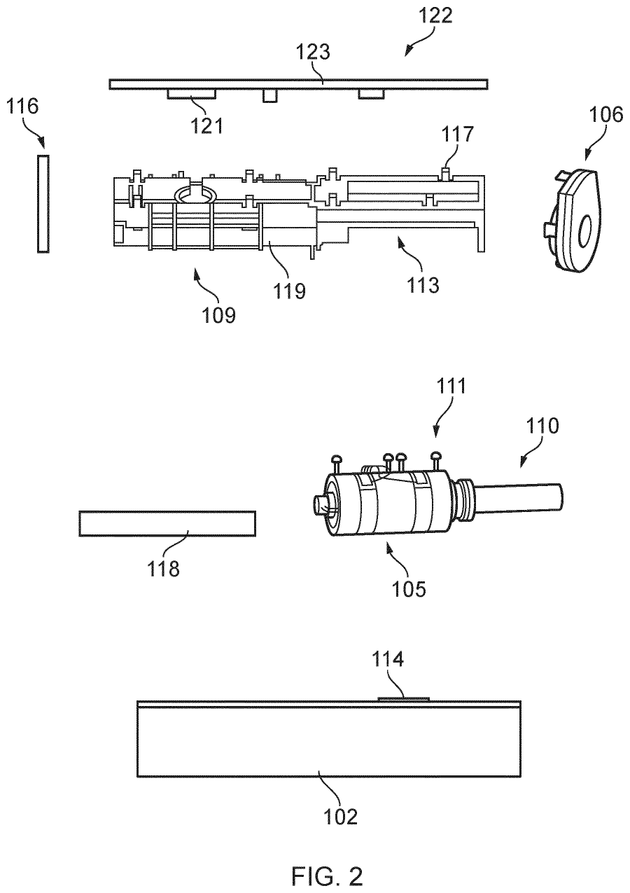

The device 100 comprises a housing 102 (including an outer cover) which surrounds and houses various components of the device 100. The device 100 has an opening 104 in one end, through which the article 110 may be inserted for heating by a heater assembly 105 (refer to FIG. 2). In use, the article 110 may be fully or partially inserted into the heater assembly 105 where it may be heated by one or more components of the heater assembly 105.

The device 100 may also include a user-operable control element 112, such as a button or switch, which operates the device 100 when pressed. For example, a user may turn on the device 100 by operating the switch 112.

The device 100 defines a longitudinal axis 101.

FIG. 2 depicts a schematic exploded view of the device 100 of FIG. 1. The device 100 comprises the outer cover 102, a first end member 106 and a second end member 116. The device 100 includes a chassis 109, a power source 118, and an aerosol generating assembly 111 including the heater assembly 105. The device 100 further comprises at least one electronics module 122.

The outer cover 102 forms part of a device shell 108. The first end member 106 is arranged at one end of the device 100 and the second end members 116 is arranged at an opposite end of the device 100. The first and second end members 106, 116 close the outer cover 102. The first and second end members 106, 116 form part of the shell 108. The device 100 in embodiments comprises a lid (not shown) which is moveable relative to the first end member 106 to close the opening 104 when no article 110 is in place.

The device 100 may also comprise an electrical component, such as a connector/port 114, which can receive a cable to charge a battery of the device 100. For example, the connector 114 may be a charging port, such as a USB charging port. In some examples the connector 114 may be used additionally or alternatively to transfer data between the device 100 and another device, such as a computing device.

The device 100 includes the chassis 109. The chassis 109 is received by the outer cover 102. The aerosol generating assembly 111 comprises the heater assembly 105 into which, in use, the article 110 may be fully or partially inserted where it may be heated by one or more components of the heater assembly 105. The aerosol generating assembly 111 and the power source 118 are mounted on the chassis 109. The chassis 109 is a one piece component.

The chassis 109 may be formed together during manufacture, for example through an injection moulding process. Alternatively, two or more features of the chassis 109 may be separately formed initially and then formed together during a manufacturing stage to form a one-piece component, for example by a welding process.

One-piece component refers to a component of the device 100 which is not separable into two or more components following assembly of the device 100. Integrally formed relates to two or more features that are formed into a one piece component during a manufacturing stage of the component.

The first and second end members 106, 116 together at least partially define end surfaces of the device 100. For example, the bottom surface of the second end member 116 at least partially defines a bottom surface of the device 100. Edges of the outer cover 102 may also define a portion of the end surfaces. The first and second end members 116 close open ends of the outer cover 102. The second end member 116 is at one end of the chassis 109.

The end of the device 100 closest to the opening 104 may be known as the proximal end (or mouth end) of the device 100 because, in use, it is closest to the mouth of the user. In use, a user inserts an article 110 into the opening 104, operates the user control 112 to begin heating the aerosol generating material and draws on the aerosol generated in the device. This causes the aerosol to flow through the device 100 along a flow path towards the proximal end of the device 100.

The other end of the device furthest away from the opening 104 may be known as the distal end of the device 100 because, in use, it is the end furthest away from the mouth of the user. As a user draws on the aerosol generated in the device, the aerosol flows in a direction towards the proximal end of the device 100. The terms proximal and distal as applied to features of the device 100 will be described by reference to the relative positioning of such features with respect to each other in a proximal-distal direction along the axis 101.

The power source 118 is disposed at the distal end of the device 100. The chassis 109 mounts the power source 118. The chassis 109 comprises a power supply mount 119. The chassis 109 partially encloses the power source 118. The power source 118 may be, for example, a battery, such as a rechargeable battery or a non-rechargeable battery. Examples of suitable batteries include, for example, a lithium battery (such as a lithium-ion battery), a nickel battery (such as a nickel-cadmium battery), and an alkaline battery. The battery is electrically coupled to the aerosol generating assembly 111 to supply electrical power when required and under control of a controller 121 to heat the aerosol generating material. In this example, the battery is connected to the chassis 109, acting as a central support, which holds the battery 118 in place.

The power source 118 and aerosol generating assembly 111 are disposed in an axial arrangement, with the power source 118 at the distal end of the device 100 and the aerosol generating assembly 111 at the proximal end of the device 100. Other configurations are anticipated. The chassis 109 comprises an aerosol generating assembly mount 113.

The device 100 further comprises at least one electronics module 122. The electronics module 122 may comprise, for example, a printed circuit board (PCB) 123. The PCB 123 may support at least one controller 121, such as a processor, and memory. The PCB 123 may also comprise one or more electrical tracks to electrically connect together various electronic components of the device 100. For example, the battery terminals may be electrically connected to the PCB 123 so that power can be distributed throughout the device 100. The connector 114 may also be electrically coupled to the battery 118 via the electrical tracks. The chassis 109 comprises a PCB mount 117.

The aerosol generating assembly 111 is an inductive heating assembly and comprises various components to heat the aerosol generating material of the article 110 via an inductive heating process. Induction heating is a process of heating an electrically conducting object (such as a susceptor) by electromagnetic induction. An induction heating assembly may comprise an inductive element, for example, one or more inductor coils, and a device for passing a varying electric current, such as an alternating electric current, through the inductive element. The varying electric current in the inductive element produces a varying magnetic field. The varying magnetic field penetrates a susceptor suitably positioned with respect to the inductive element, and generates eddy currents inside the susceptor. The susceptor has electrical resistance to the eddy currents, and hence the flow of the eddy currents against this resistance causes the susceptor to be heated by Joule heating. In cases where the susceptor comprises ferromagnetic material such as iron, nickel or cobalt, heat may also be generated by magnetic hysteresis losses in the susceptor, i.e. by the varying orientation of magnetic dipoles in the magnetic material as a result of their alignment with the varying magnetic field. In inductive heating, as compared to heating by conduction for example, heat is generated inside the susceptor, allowing for rapid heating. Further, there need not be any physical contact between the inductive heater and the susceptor, allowing for enhanced freedom in construction and application.

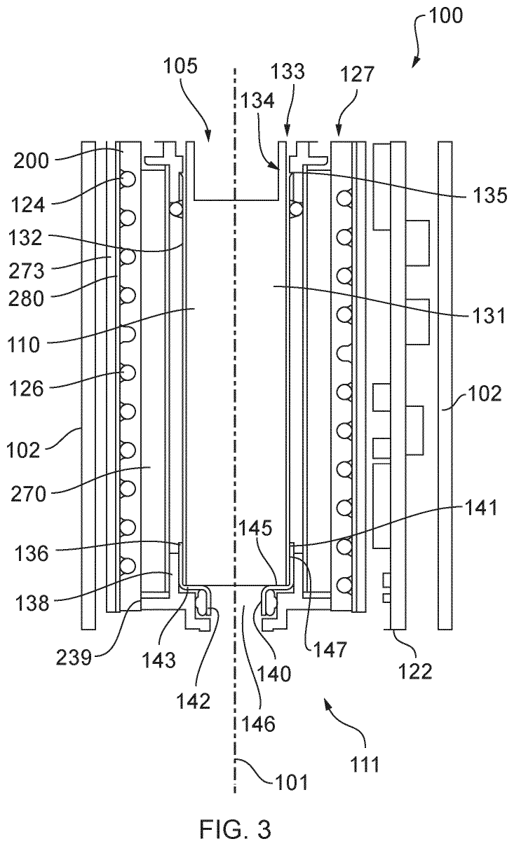

FIG. 3 shows a close up side view of part of the device 100 in partial cross-section. The outer cover 102 encloses the aerosol generating assembly 111. The aerosol generating assembly 111 of the device 100 comprises the heater assembly 105 and an inductor coil assembly 127. The inductor coil assembly 127 extends around the heater assembly 105. The inductor coil assembly 127 includes a first inductor coil 124 and a second inductor coil 126. The inductor coil assembly 127 also comprises a coil support 200.

The heater assembly 105 includes a susceptor arrangement 132 (herein referred to as “a susceptor”). The susceptor 132 of this example is hollow and therefore defines a receptacle 131 within which aerosol generating material is received. For example, the article 110 can be inserted into the susceptor 132. In this example the susceptor 132 is tubular, with a circular cross section. The susceptor 132 defines a first portion of the heater assembly 105. The susceptor 132 has a generally constant diameter along its axial length. The susceptor 132 has a flared portion 134 at a first, proximal, end 133. The flared portion 134 diverges outwardly. The flared portion 134 defines an outwardly extending lip 135. That is the lip 135 has a greater diameter than the outer diameter of the main portion of the susceptor 132. The lip 135 acts to minimize contact of the susceptor 132 with other components at the first end 133. This arrangement helps with a low heat transmission, for example through conduction, when the susceptor 132 is heated.

The susceptor 132 is formed from an electrically conducting material suitable for heating by electromagnetic induction. The susceptor in the present example is formed from a carbon steel. It will be understood that other suitable materials may be used, for example a ferromagnetic material such as iron, nickel or cobalt.

FIG. 3 shows a portion of the article 110 received within the receptacle 131 provided by the susceptor 132. The susceptor 132 and article 110 are dimensioned so that the article 110 is received by the susceptor 132. The article 110 of this example comprises aerosol generating material. The aerosol generating material is positioned within the susceptor 132. The article 110 may also comprise other components such as a filter, wrapping materials and/or a cooling structure.

The heater assembly 105 also comprises a funnel part 140. The funnel part 140 is at a second, distal, end 136 of the susceptor 132. The funnel part 140 protrudes from the susceptor 132. In embodiments, the susceptor 132 and funnel part 140 are a one-piece component.

The funnel part 140 has a thimble arrangement. The funnel part 140 is at the second, distal, end 136 of the susceptor 132. The funnel part 140 defines a second portion of the heater assembly 105. The funnel part 140 comprises a first section 141 having a first diameter and a second section 142 having a second diameter. An intermediate section 143 extends between the first and second sections 141, 142. The first section 141 is tubular and extends in the axial direction. The second section 142 is tubular and extends in the axial direction. The funnel part 140 is hollow. The intermediate section 143 forms a shoulder 145. The shoulder 145 acts as a stop to limit insertion of the article 110 into the receptacle. The shoulder 145 extends on a substantially perpendicular plane to the longitudinal axis 101.

The first section 141 has an inner diameter which is greater than the inner diameter of the second section 142. The funnel part 140 therefore converges from the first section 141 to the second section 142. The funnel part 140 therefore reduces in diameter from a susceptor end 148 to a distal end 149.

The funnel part 140 defines an air passage 146 therethrough. The first section 141 and the susceptor 132 partially overlap with each other at one end of the susceptor 132. In an example, the overlap is between about 1 mm and about 3 mm. In this particular example, the overlap is 2 mm. In examples, there is no overlap. In such an example the susceptor 132 and funnel part 140 abut. The first section 141 overlaps the second, distal, end 136 of the susceptor 132. The first section 141 is generally cylindrical and has an inner diameter substantially corresponding to the outer diameter of the susceptor 132. The first section 141 abuts the susceptor 132. A juncture 147 is formed between the first section 141 of the funnel part 140 and the susceptor 132. The juncture 147 assists with forming a thermally conductive path between the susceptor 132 and the funnel part 140.

The juncture 147 is a fluidly sealed juncture. A fluid seal is formed between the susceptor 132 and the funnel part 140. As such a fluidly sealed fluid path is defined between the opposing ends of the susceptor 132 and the funnel part 140. The receptacle defined by the susceptor 132 therefore forms a fluid seal air path with the air passage 146 formed by the funnel part 140.

The fluid seal at the juncture 147 is formed in embodiments by a mechanical fabricated joint, for example a weld. The fluid seal at the juncture 147 is formed by a laser weld process, however it will be understood that other methods may be used such as brazing and adhering. The funnel part 140 is formed from a thermally conductive material. In embodiments, the funnel part 140 is formed from a carbon steel. The funnel part in embodiments is formed from the same material as the susceptor 132. The juncture is configured to retain a fluid seal when the susceptor 132 is at its predetermined operating temperature. By such processes the susceptor 132 and funnel part 140 are fabricated as a one-piece component.

The sealed fluid path between the susceptor 132 and the funnel part 140 therefore extends through the heater assembly 105 from one open end of the heater assembly 105 to the other open end of the heater assembly 105. As such, any fluid flow through the heater assembly 105 is contained in the heater assembly 105. A dry zone may be defined outside the heater assembly 105.

The abutment of the susceptor 132 and the funnel part 140 provides for heat transfer by conduction from the susceptor 132 to the funnel part 140. As such, it is possible to aid passive heating of the funnel part 140. By passively heating the funnel part 140 it is possible to restrict the rate of build up of condensate in the device 100.

The funnel part 140 is axially spaced from the inductor coil assembly 127. In particular, the second section 142 of the funnel part 140 is axially spaced from the inductor coil assembly 127. As such, there is minimal or no direct heating of the funnel part 140 by the inductor coil assembly 127. The funnel part 140 may lie adjacent to the inductor coil assembly 127 in an axial direction.

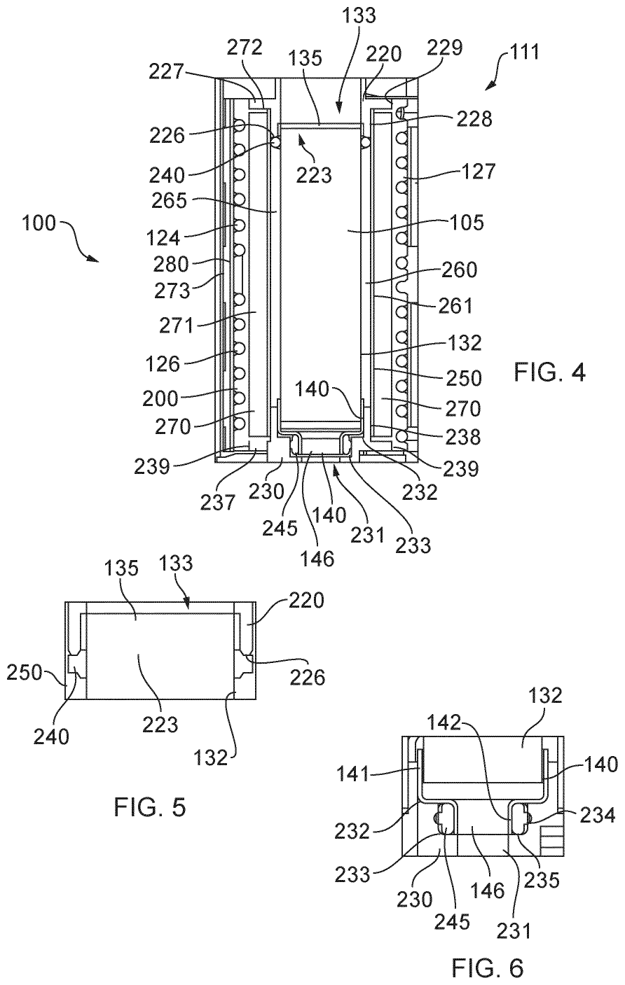

Referring in particular to FIGS. 4 to 8, the device 100 comprises a first end support 220 and a second end support 230. The heater assembly 105 extends between the first and second end supports 230. A barrier member 250 extends between the first end support 220 and the second end support 230. The barrier member 250 acts as a support member.

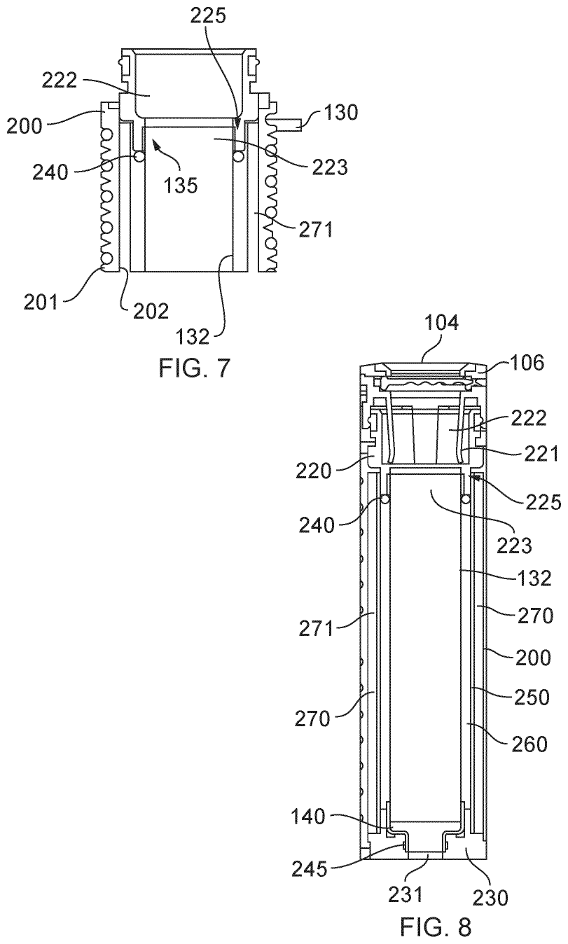

The first end support 220 engages the first, proximal, end of the heater assembly 105 to hold the susceptor 132 in place. The first end support 220 acts as an expansion chamber, as described below. Referring to FIGS. 7 and 8 in particular, the first end support 220 extends away from the first end of the susceptor 132 towards the opening 104 of the device. Located at least partially within the first end support 220 is a retention arrangement 221, such as a retention clip, to abut and hold the article 110 when received within the device 100. The first end support 220 is connected to the end member 106.

The first end support 220 comprises a chamber 222. The chamber 222 is configured to receive the article 110 therethrough. The retention arrangement 221 is in the chamber 222. The chamber 222 has an inner diameter greater than the diameter of the article 110. The first end support 220 forms a first, proximal, collar for the heater assembly 105. A bore 223 extends therethrough. As shown, for example, in FIGS. 7 and 8, a distally facing shoulder 225 is defined on the inner surface of the bore 223. The distally facing shoulder 225 locates with the lip 135 of the susceptor 132 when the susceptor is received by the first end support 220.

Referring now in particular to FIGS. 4 and 5, the first end support 220 forms a sealing rim 226 on a distal side of the first end support 220. The distal sealing rim 226 extends about the bore 223. A first mounting flange 227 extends from a first, proximal, end outer surface 228 of the first end support 220. The first mounting flange 227 extends circumferentially and is spaced from the sealing rim 226. The first mounting flange 227 upstands from the first end outer surface 228 and forms a first, proximal, end mounting surface 229. The first, proximal, end outer surface 228 and the first end mounting surface 229 define a stepped configuration. The first end mounting surface 229 has a greater diameter than the first end outer surface 228. In embodiments, the first end outer surface 228 and first end mounting surface define first and second step faces.

Referring in particular to FIGS. 4 to 8, the device 100 further comprises the second end support 230 which engages the funnel part 140 at the second, distal, end of the susceptor 132 to hold the heater assembly 105 in place. The second end support 230 forms a second, distal, collar for the heater assembly 105. In embodiments in which the funnel part is omitted, the second end support 230 engages the susceptor 132 directly. The second end support 230 acts as an air inlet, as will be described below. The second end support 230 extends away from the second end of the susceptor 132 towards the distal end of the device 100.

Referring in particular to FIGS. 4 and 6, the second end support 230 comprises a second end bore 231. The second end support 230 is configured to at least partially receive the funnel part 140. The inner surface of the second end support 230 is stepped. The inner surface comprises a first stepped region 232 with a first step, and a second stepped region 233 with a second step. The first stepped region 232 receives the first section 141 of the funnel part 140. The second stepped region 233 receives the second section 142 of the funnel part 140. The second stepped region 233 includes a first sealing face 234. The second stepped region 233 includes a second sealing face 235. The first sealing face 234 is an internal circumferentially extending face. The second sealing face 235 is a circumferentially extending face extending on a plane substantially perpendicular to the longitudinal axis 101.

A second mounting flange 237 extends from a second, distal, outer surface 238 of the second end support 230. The second mounting flange 237 extends circumferentially and is spaced from a proximal end of the second end support 230. The second mounting flange 237 upstands from the second end outer surface 238 and forms a second, distal, end mounting surface 239. The second, distal, end outer surface 238 and the second, distal, end mounting surface 239 define a stepped configuration. The second end mounting surface 239 has a greater diameter than the second end outer surface 238. In embodiments, the second end outer surface 238 and second end mounting surface 239 define first and second step faces.

The barrier member 250 extends between the first end support 220 and the second end support 230. The barrier member 250 extends between the first and second end supports 220, 230. The barrier member 250 together with the first and second end supports 220, 230 encloses the heater assembly 105. This acts to assist with thermally isolating the heater assembly 105 from other components of the device 100. The barrier member 250 is a hollow, tubular member.

The barrier member 250 is fixedly mounted to the first and second end supports 220, 230. The first and second end supports, 220, 230 are received in the ends of the barrier member 250. The first end support 220 closes the proximal end of the barrier member 250. The second end support 230 closes the distal end of the barrier member 150. The barrier member 250 partially overlaps the first and second end supports, 220, 230. In an example, the overlap is between about 2 mm and about 3 mm. In this particular example, the overlap is about 2.2 mm. In examples, there is no overlap. The proximal end of the barrier member 250 abuts the first end outer surface 228. The distal end of the barrier member 250 abuts the second end outer surface 238.

The barrier member 250 is fixedly mounted to the first and second end supports 220, 230. The barrier member 250 forms a fluid seal with the first and second end supports 220, 230. In embodiments a mechanical fabricated joint, for example a weld, is formed between the barrier member 250 and each of the first and second end supports 220, 230. The fluid seal at the junction of the parts is formed by a weld process, however it will be understood that other methods may be used such as brazing and adhering. In embodiments, the barrier member 250, and first and second end supports 220, 230 are formed from the same material. The junction is configured to retain a fluid seal when the susceptor 132 is at its predetermined operating temperature. By such a process the barrier member 250 and the first and second end supports 220, 230 are fabricated as a one-piece component.

In embodiments, the barrier member 250 is formed from a non-metallic material to assist with limiting interference with magnetic induction. In this particular example, the barrier member 250 is constructed from polyether ether ketone (PEEK). The first and second end supports 220, 230 are constructed from PEEK. Other suitable materials are possible. Parts formed from such materials help ensure that the barrier member 250 remains rigid/solid when the susceptor is heated. The barrier member 250 is formed from a rigid material to aid support of other components, such as the heater assembly 105 and the end supports 220, 230. The barrier member 250 may be constructed from an insulating material, such as plastic for example. In an example, the barrier member 250 has a thickness between about 0.1 mm and about 0.5 mm. In the present example, the thickness is about 0.3 mm.

The heater assembly 105, the barrier member 250, and the first and second end supports 220, 230 are coaxial around the central longitudinal axis of the susceptor 132. The barrier member 250 may help insulate the various components of the device 100 from the heat generated in the susceptor 132.

A radial gap is provided between the susceptor 132 and the first end support 220. The diameter of the bore 223 is greater than the diameter of the external face of the susceptor 132. The radial gap is approximately 0.2 mm, although the gap may differ. The provision of the radial gap aids with minimizing heat transfer between the susceptor 132 and the first end support 220.

Referring now in particular to FIGS. 4 to 6, a first sealing member 240 forms a fluid seal between the heating assembly 105 and the first end support 220. The first sealing member 240 is a circumferentially extending member. The first sealing member 240 comprises a silicon rubber seal. Other suitable materials may be used. The first sealing member 240 is resilient. The material is configured to be stable when the heating assembly 105 is at operating temperature. The first sealing member 240 is fixedly mounted on the susceptor 240. The first sealing member 240 is adhered to the susceptor 132, for example by overmoulding of the first sealing member 240 on the outer surface of the susceptor 132. The first sealing member 240 is spaced from the proximal end of the susceptor 132. When the proximal end of the susceptor 132 is received by the first end support 220, the sealing rim 226 of the first end support 220 abuts with and seals against the first sealing member 240. As such a seal is formed between the first end support 220 and the susceptor 220. The first sealing member 240 forms a seal in the axial direction.

The first sealing member 240 abuts with and seals against the barrier member 250. The first sealing member 240 upstands from the susceptor 132. The first sealing member 240 abuts the internal surface of the barrier member 250. Accordingly, a seal is formed between the susceptor 132 and the barrier member 250. The first sealing member 240 forms a seal in the radial direction. The first sealing member 240 acts to locate and orientate the susceptor with respect to the first end support 220 and the barrier member 250.

A second sealing member 245 forms a fluid seal between the heating assembly 105 and the second end support 230. The second sealing member 245 is a circumferentially extending member. The second sealing member 245 comprises a silicon rubber seal. Other suitable materials may be used. The second sealing member 245 is resilient. The material is configured to be stable when the heating assembly 105 is at operating temperature. The second sealing member 245 is fixedly mounted on the funnel part 140. In embodiments, the second sealing member is on the susceptor 132, for example where the funnel part is omitted. The second sealing member 245 is adhered to the susceptor 132, for example by overmoulding of the second sealing member 245 on the outer surface of the funnel part 140. The second sealing member 245 is adjacent to the open end of the funnel part 140. When the distal end of the heating assembly is received by the second end support 230, the first sealing face 234 of the second end support 230 abuts with and seals against the second sealing member 245. As such a seal is formed between the second end support 230 and the heating assembly 105. The second sealing member 245 forms a seal in the radial direction.

The second sealing member 245 abuts with and seals against the second sealing face 235 of the second end support 230. The second sealing member 245 forms a seal in the axial direction. The second sealing member 245 upstands from the heater assembly 105. The second sealing member 245 acts to locate and orientate the heater assembly 105 with respect to the second end support 230 and the barrier member 250.

In embodiments, the first sealing member 240 is on the first end support 220 and seals with the heater assembly 105. In embodiments, the second sealing member 245 is on the second end support 230 and seals with the heater assembly 105. The second sealing member 245 is on the second section 142 of the funnel part 140. In embodiments, the second sealing member 245 is on the first section 141 of the funnel part 140. In such an embodiment, the second sealing member 245 seals against a proximal rim of the second end support 230.

The first sealing member 240 and second sealing member 250 form a sealed air flow path through the second sealing member 250, heater assembly 105 and first sealing member 240. The barrier member 250 and the first and second end supports 220, 230 form a contiguously sealed enclosure for the heater assembly 105. The barrier member 250 is spaced from the susceptor 132. An inner surface of the barrier member 250 is positioned away from the outer surface of the susceptor 132 to provide an air gap between the barrier member 250 and the heater assembly 105. The air gap provides insulation from the heat generated in the susceptor 132.

A fluidly sealed cavity 260 is formed between the heater assembly 105 and the barrier member 105. The fluidly sealed cavity 260 forms a chamber. The cavity 260 provides an air gap. A fluidly sealed enclosure 261 is formed around part of the heater assembly 105. The fluidly sealed enclosure is formed by the barrier member 105, first and second sealing members 240, 245, heater assembly 105 and the second end support 230. In some embodiments, the first end support 220 forms part of the enclosure 261. In some embodiments, the fluidly sealed enclosure 261 is formed by the barrier member 105, heater assembly 105 and first and second sealing members 240, 245. In embodiments, the gap between the heater assembly 105 and the barrier member 105 is between about 0.8 mm and 1 mm. In embodiments, the gap is about 0.9 mm.

A sensor, such as a thermocouple 265, is disposed in the fluidly sealed cavity 260. The thermocouple 265 is mounted on the susceptor 132. The thermocouple 265 is configured to determine the temperature of the susceptor 132. The thermocouple 265 directly detects the temperature of the susceptor 132. The device 100 may comprise two or more thermocouples 132 configured to determine the temperature of the susceptor 132. The provision of the fluidly sealed cavity 260 helps to isolate the thermocouples 265 from atmosphere external to the fluidly sealed cavity 260. The provision of the fluidly sealed cavity 260 helps to isolate the thermocouples 265 from the air flow path through the device 100. As such, condensate from the air flow path is restricted from flowing to the thermocouples 265.

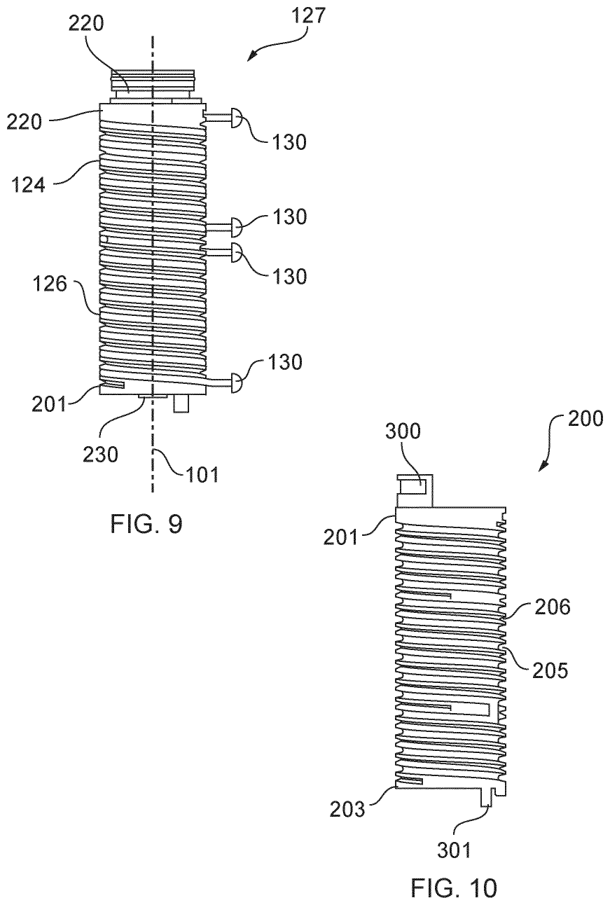

Referring to FIGS. 9 and 10 in particular, the inductor coil assembly 127 includes the first inductor coil 124 and the second inductor coil 126. The first and second inductor coils 124, 126 are made from an electrically conducting material. In this example, the first and second inductor coils 124, 126 are made from Litz wire/cable which is wound in a helical fashion to provide helical inductor coils 124, 126. Litz wire comprises a plurality of individual wires which are individually insulated and are twisted together to form a single wire. Litz wires are designed to reduce the skin effect losses in a conductor. In the example device 100, the first and second inductor coils 124, 126 are made from copper Litz wire which has a circular cross section. In other examples the Litz wire can have other shape cross sections, such as rectangular. The number of inductor coils may differ. For example, in embodiments the inductor coil assembly 127 may include a single inductor coil. The first or second inductor coil may be omitted.

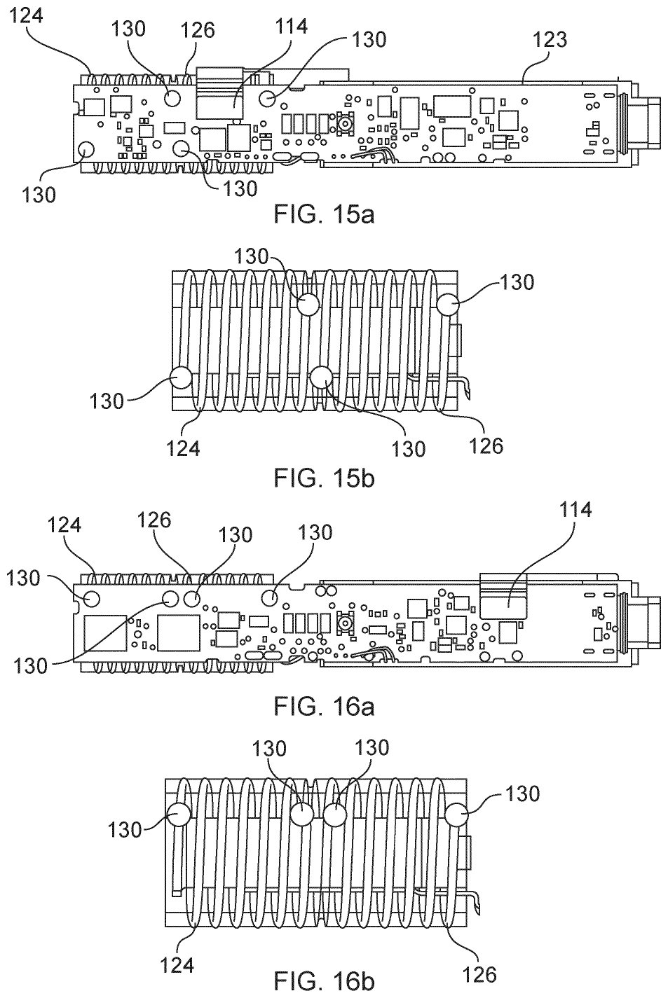

The first inductor coil 124 is configured to generate a first varying magnetic field for heating a first section of the susceptor 132 (refer to FIG. 4) and the second inductor coil 126 is configured to generate a second varying magnetic field for heating a second section of the susceptor 132. In this example, the first inductor coil 124 is adjacent to the second inductor coil 126 in a direction along the longitudinal axis 101 of the device 100 (that is, the first and second inductor coils 124, 126 do not overlap) as shown in FIGS. 15b and 16b. The susceptor arrangement 132 may comprise a single susceptor, or two or more separate susceptors. Ends 130 of the first and second inductor coils 124, 126 can be connected to the PCB 123 (refer to FIG. 2).

It will be appreciated that the first and second inductor coils 124, 126, in some examples, may have at least one characteristic different from each other. For example, the first inductor coil 124 may have at least one characteristic different from the second inductor coil 126. More specifically, in one example, the first inductor coil 124 may have a different value of inductance than the second inductor coil 126. In FIGS. 3 and 4, the first and second inductor coils 124, 126 are of different lengths such that the first inductor coil 124 is wound over a smaller section of the susceptor 132 than the second inductor coil 126. Thus, the first inductor coil 124 may comprise a different number of turns than the second inductor coil 126 (assuming that the spacing between individual turns is substantially the same). In yet another example, the first inductor coil 124 may be made from a different material to the second inductor coil 126. In some examples, the first and second inductor coils 124, 126 may be substantially identical.

In this example, the first inductor coil 124 and the second inductor coil 126 are wound in the same direction. The inductor coils may be active at different times. For example, initially, the first inductor coil 124 may be operating to heat a first section of the article 110, and at a later time, the second inductor coil 126 may be operating to heat a second section of the article 110. In embodiments, the first inductor coil 124 and the second inductor coil 126 are wound in opposite directions. Winding the coils in opposite directions helps reduce the current induced in the inactive coil when used in conjunction with a particular type of control circuit. In such an embodiment, the first inductor coil 124 may be a right-hand helix and the second inductor coil 126 may be a left-hand helix. In another embodiment, the first inductor coil 124 may be a left-hand helix and the second inductor coil 126 may be a right-hand helix.

It will be understood that the number of inductor coils may differ. In embodiments, the device 100 comprises a single inductor coil.

The device 100 comprises a coil support 200 acting as a support member. The support member may be generally tubular and at least partially surround the susceptor 132. The support member 200 supports the first and second inductor coils 124, 126. The coil support 200 is shown in cross-section in FIG. 4. A side view of the coil support 200 is shown with various parts of the device 100 omitted in FIG. 9. The coil support 200 is shown in FIG. 10.

The coil support 200 extends between the first and second end supports 220, 230. The coil support 200 together with the first and second end supports 220, 230 encloses the heater assembly 105. This acts to assist with thermally isolating the heater assembly 105 from other components of the device 100. The coil support 200 is a hollow, tubular member.

In embodiments, the coil support 200 is formed from a non-metallic material to assist with limiting interference with magnetic induction. In this particular example, the coil support 200 is constructed from polyether ether ketone (PEEK). Other suitable materials are possible. Coil supports formed from such materials ensure that the assembly remains rigid/solid when the susceptor is heated. The coil support 200 is formed from a rigid material to aid support of other components, such as the coils 124, 126. The coil support 200 may be constructed from an insulating material, such as plastic for example. In an example, the coil support 200 has a thickness between about 1 mm and 1.5 mm. In the present example, the thickness is about 1.3 mm.

As shown in FIGS. 3, 4 and 9 in particular, the first and second inductor coils 124, 126 are positioned around the coil support 200 and abut the coil support 200. The first and second inductor coils 124, 126 are on a radially outward side 201 of the coil support 200. In embodiments, the first and second inductor coils are on a radially inward side 202 of the coil support 200.

The susceptor 132, the coil support 200, and the first and second inductor coils 124, 126 are coaxial around the central longitudinal axis 101 of the susceptor 132. The coil support 200 may help insulate the various components of the device 100 from the heat generated in the susceptor 132.

The coil support 200 has an outer surface 203. The outer surface 203 is spaced away from the outer cover 102. The coil support 200 is spaced from the heater assembly 105. The coil support 200 has an inner surface which is positioned away from the outer surface 203 of the susceptor 132.

The coil support 200 is fixedly mounted to the first and second end supports 220, 230. The first and second end supports, 220, 230 are received in the ends of the coil support 200. The first end support 220 closes the proximal end of the coil support 200. The second end support 230 closes the distal end of the coil support 200. The coil support 200 partially overlaps the first and second end supports, 220, 230. The proximal end of the barrier member 250 abuts the first end outer surface 228. The distal end of the barrier member 250 abuts the second end outer surface 238. The proximal end of the coil support 220 overlaps the first, proximal, end mounting surface 229 of the first end support 220. The distal end of the coil support 220 overlaps the second, distal, end mounting surface 229 of the second end support 230.

The coil support 200 is fixedly mounted to the first and second end supports 220, 230. The coil support 200 is retained between the first and second end supports 220, 230. In embodiments a mechanical fabricated joint, such as welding or adhering fixes the coil support 200 in place. In embodiments, the coil support 200, and first and second end supports 220, 230 are formed from the same material.

Referring in particular to FIGS. 3, 4, 9 and 10, the first and second inductor coils 124, 126 may be aligned on the coil support 200 by the coil support 200. That is, in some examples, the first and second inductor coils 124, 126 may be retained in a specific arrangement with respect to the coil support 200 by a feature of the coil support 200. The alignment feature in some examples may be a channel 205. The channel 205 may be formed in the radially outward side 201 of the coil support 200. The channel 205 may be a helical channel 205. In some examples that comprise this alignment feature, the channel 205 may receive the first and second inductor coils 124, 126. In that example, the first and second inductor coils 124, 126 may be retained by the channel 205. The channel 205 follows a constant helical path. The channel 205 comprises a plurality of turns around the coil support 200. The channel 205, acting as an alignment feature provides for a consistent path of the coils 214, 216, for example consistent spacing. This helps the performance of the inductor coil assembly to be maximized, and/or for a predetermined attribute of the coil to be achieved.

Each of the first and second inductor coils 124, 126 are aligned on the coil support 200 in a helical arrangement. One of the inductor coils in examples may be omitted. Each of the first and second inductor coils 124, 126 follows a helical path. Turns of the helical path of each of the first and second inductor coils 124, 126 have equal spacing.

In embodiments, the helical channel 205 is formed by a groove in the outer surface 203 of the support coil 200. In embodiments, the helical channel 205 is formed by a pair of adjacent ridges extending in a helical arrangement. The ridges be non-continuous and may be formed from a plurality of protrusions. The protrusions may define a helical path in which the support coil is received and retained.

In some embodiments, the coil support 200 may comprise a helical recess 206 between adjacent turns of the channel 205. The helical recess 206 is an elongate groove. In examples, the helical recess 206 comprises a plurality of recess sections. The helical recess 206 in examples acts as an air gap. The provision of the helical recess aids with restricting heat transfer. The provision of the helical recess may aid weight minimization. The helical recess 206 forms a double helix configuration with the channel 205. In embodiments, the helical recess is omitted. The helical recess is not shown in FIGS. 3 and 4.

The first and second inductor coils 124, 126 may be retained in the channel 205. Retention features such as clips, bonding, and an over layer may be used to retain the first and second inductor coils 124, 126 in the channel 205.

Each of the first and second inductor coils 124, 126 may be fully received in the coil support 200. That is each of the first and second inductor coils 124, 126 lies planar with or recessed from the surface of the coil support 200. In embodiments, the first and second inductor coils 124, 126 partially protrude from the channel 205.

The coil support 200 comprises a single channel. However, it will be understood that the channel 205 may be separated into two channel portions, one for each coil 124, 126. Each channel may have one or more different properties, for example pitch, width, depth and length to provide a different alignment between the coils 124, 126.

A ferrite shield 280 extends around the inductor coils 124, 126. The ferrite shield acts as an electromagnetic shield. Other suitable materials may be used. The ferrite shield 280 is mounted on the coil support 200. The ferrite shield 280 abuts the coils support 200 and so may be directly mounted to the coil support 200, for example by adhering. The channel 205 provides for the coils 124, 126 to be recessed in the coil support 200. The inductor coils 124, 126 are enclosed by the coil support 200 and the ferrite shield 280.

Referring to FIG. 12, a sensor 290, such as a thermocouple, may be positioned on the coil support 200. The coil support 200 comprises a sensor mount 291. This assists with accurately positioning the sensor with respect to the coil, and so aids accurate measurement. The mount 291 comprises a recess. The mount 291 forms a locating surface for mounting the thermocouple.

The alignment feature in the above described embodiments is the channel. However, it will be understood that the channel may be omitted and the alignment feature may vary.

In the above described embodiments, the coil support 200 is provided with the channel 205 for aligning the coils and/or other alignment features. It will be understood that in some embodiments the channels for aligning the coils and/or other alignment features may be omitted. In such an embodiment the coils may be adhered to a surface of the coil support, or may be assembled around the coil support with a gap therebetween.

The heater assembly 105, the barrier member 250, and the coil support 200 are coaxial around the central longitudinal axis of the susceptor 132. The coil support 200 may help insulate the various components of the device 100 from the heat generated in the susceptor 132.

The coil support 200 is spaced from the susceptor 132. The coil support 200 is spaced from the barrier member 250. The barrier member 250 is between the heater assembly 105 and the coil support 200. An insulation chamber 270 is formed between the coil support 200 and the barrier member 250.

In an example, the spacing between the coil support 200 and the barrier member 250 is between 0.5 mm and 1.5 mm. In the present example, the thickness is about 0.9 mm. The coil support 200 acts as a second barrier member. By providing barrier members, acting as barriers, in a spaced apart arrangement it is possible to help provide separate chambers to assist with isolating different components of the device from each other.

The barriers act as insulation members. As such, the barriers form part of an insulation stack to limit thermal transfer from the susceptor 132 to external of the aerosol generating assembly 111. The barrier member 250 acts as a first insulating member. The coil support 200 acts as a second insulating member. An insulating layer 271 extends between the barrier member 250 and the coil support 200. The insulating layer 271 extends around the barrier member 250. The insulating layer 271 abuts the barrier member 250 and the coil support 200.

In embodiments, the insulating layer 271 is supported by the barrier member 250 and the coil support 200. In some embodiments the insulating layer 271 is supported by the barrier member 250. In such embodiments, the insulating layer 271 may be spaced, for example by a small gap, from the coil support 200. In some embodiments the insulating layer 271 is supported by the coil support 200. In such embodiments, the insulating layer 271 may be spaced, for example by a small gap, from the barrier member 250. The insulating layer 271 may be attached to one or both of the barrier member 250 and coil support 200. In embodiments, the barrier member 250 may be omitted. In embodiments, the coil support 200 may be integrally formed with the insulating layer 271. The insulating layer 271 may be omitted. In such embodiments, an air gap is formed between the barrier member 250 and the coil support 200. In such an arrangement, the air gap acts as an insulator.

The insulating layer 271 acts as a third insulating member. The insulating layer is tubular. The insulating layer 271 may be a panel. The insulating layer 271 in embodiments is formed around the inner side of the coil support 200 in a tubular arrangement. End lips 272 (refer to FIG. 4) help to retain the insulating layer 271. The insulating layer 271 is adhered to the coil support 20. In examples, the insulating layer 271 is adhered to the barrier member 250. The barrier member 250 spaces the insulating layer 271 from the susceptor 132. The coil support 200 spaces the insulating layer 271 away from the inductor coils 124, 126.

The insulating stack may be provided by a combination of two or more of the following materials (i) air (which has a thermal conductivity of about 0.02 W/mK), (ii) Aerogel, for example AeroZero® (which has a thermal conductivity of between about 0.03 W/mK and about 0.04 W/mK), (iii) polyether ether ketone (PEEK) (which may have a thermal conductivity of about 0.25 W/mK in some examples), (iv) ceramic cloth (which has a specific heat of about 1.13 kJ/kgK), (v) thermal putty. Other suitable materials may be used.

The insulating layer 271 is formed from aerogel. Other suitable materials may be used, for example a porous foam material. By providing barrier members either side of the aerogel, for example, it is possible to provide a protective barrier for the insulating layer 271. The one or more barriers helps to support the insulating layer 271 along its length.

A combination of a barrier member with an aerogel insulating layer assists with providing an enhanced insulating configuration around the heater assembly 105 to restrict heat transfer to the shell of the device 100 in a compact arrangement.

The insulating layer 271 acts as an inner insulating layer 273. An outer insulating layer 273 extends around the inductor coil assembly 127. The outer insulating layer 273 forms a tubular arrangement. The outer insulating layer 273 is supported by the inductor coil assembly 127. The inner and outer insulating layers 271, 273 sandwich the inductor coil assembly 127. The outer insulating layer 273 is mounted on the ferrite layer 280. The outer insulating layer 273 is adhered to the ferrite layer 280, although other mounting arrangements are anticipated. By providing an outer insulating layer 273 allows for a predetermined thickness of insulation to be used whilst allowing for the distance between the coils and the susceptor 132 to be varied. The outer insulating layer 273 is formed from aerogel. Other suitable materials may be used, for example a porous foam material.

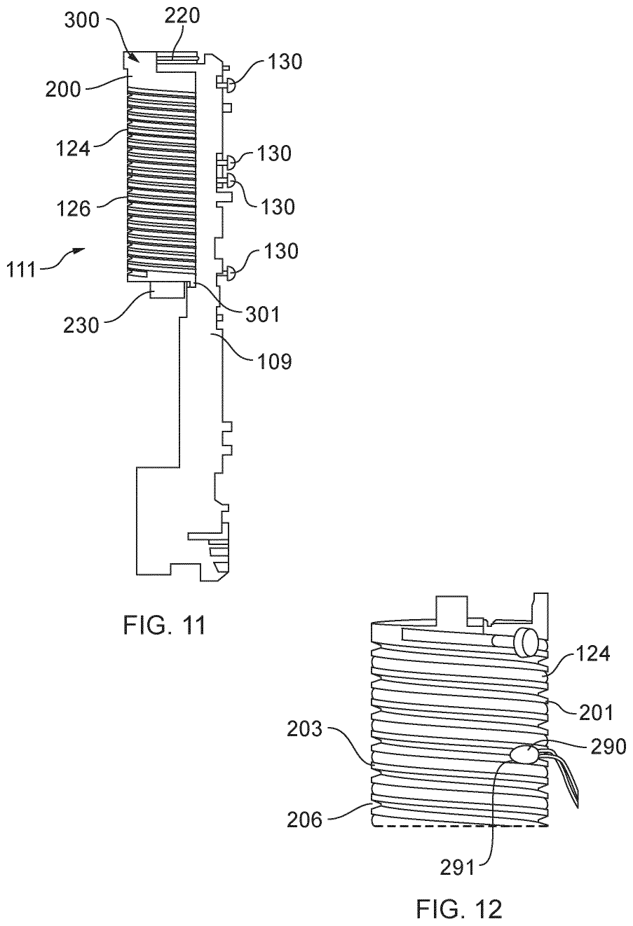

Referring to FIG. 11, the first end support 220 protrudes from the proximal end of the coil support 200. The second end support 230 protrudes from the distal end of the coil support 200. The first end support 220 is axially aligned. The second end support 230 is axially aligned. The aerosol generating assembly 111 is mounted to the chassis 109. The aerosol generating assembly 111 is mounted at its proximal and distal ends. The aerosol generating assembly mount 113 of the chassis 109 holds the aerosol generating assembly 111. A first locating feature 300 locates the aerosol generating assembly 111 on the chassis 109 at the first, proximal, end. A second locating feature 301 locates the aerosol generating assembly 111 on the chassis 109 at the second, distal, end.

The inductor coil ends 130 extend from the aerosol generating assembly 111. The inductor coil ends 130 are supported on the chassis 109. The inductor coil ends 130 are connected with the PCB 123.

The outer cover 102 provides protection to the internal components of the device, and is generally in contact with a user's hand when the device is in use. The outer cover 102 comprises an inner surface and an outer surface.

In some examples the inductor coil itself may heat up as it is used to induce a magnetic field, for example from resistive heating due to the current passing through it to induce the magnetic field. Providing an insulating layer between the inductor coil and outer cover helps ensure that the heated inductor coil is insulated from the outer cover. The ferrite shielding helps insulate the outer cover. It has been found that when the ferrite shielding is in contact with, and at least partially surrounds the one or more inductor coils, the surface temperature of the outer cover can be reduced by about 3° C.

Although each of the susceptor 132, barrier member 250, and coil support 200 have a circular shaped cross section, their cross sections may have any other shape, and in some examples may be different to each other.

As mentioned above, the inductor coil ends 130 extend from the aerosol generating assembly 111 and are supported on the chassis 109. The inductor coil ends 130 are then connected with the PCB 123.

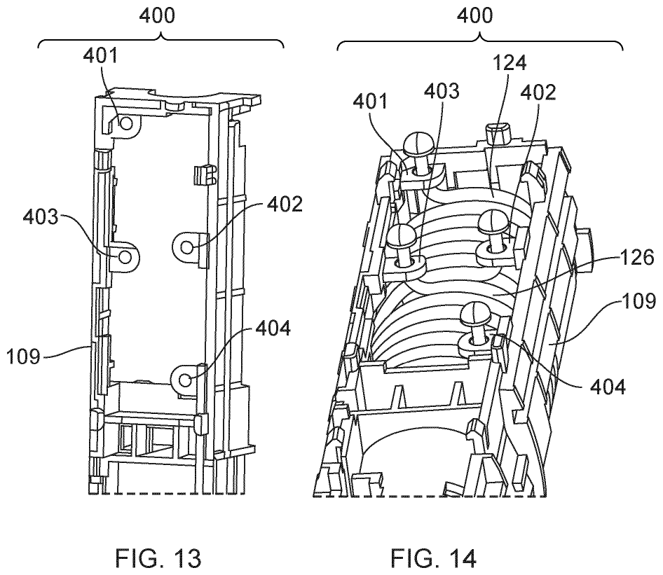

In some examples, such as those shown in FIGS. 13 to 16b, and as described below, the aerosol provision device may have a chassis 109 that further comprises a coil wire end positioning arrangement 400 that is arranged and configured to position, hold and align the coil wire ends 130 relative to each other and/or with and relative to the PCB 123. In other examples, not shown in the figures, the wire positioning arrangement 400 can be used to position, hold and align the coil wire ends 130 relative to each other and/or with and relative a different electrical component, that is not a PCB 123. In the examples shown herein and described below, however, the electrical component is a PCB 123.

The chassis 109 comprises an electrical component mount, which in the examples shown herein is a PCB mount 117 onto which the electrical component or PCB 123 is positioned in use. As mentioned above, an aerosol generating assembly 111 is provided on the chassis 109, the aerosol generating assembly having a heater assembly 105 (as shown in FIG. 2) that is configured to receive aerosol generating material. The heater assembly 105 further comprises a susceptor 132 (as shown in FIG. 3) which is heatable by penetration with a varying magnetic field. In some examples, a first inductor coil 124 extends around the heater assembly 105 and the inductor coil 124 and is configured to generate the varying magnetic field.

In some embodiments, only one inductor coil 124 may be provided. The inductor coil 124 comprises a coil wire with first and second coil wire ends 130 each of which are connected to and engaged with the electrical component, e.g. PCB 123 in use. In some examples, the first coil wire end 130 of the inductor coil 124 may be referred to as the proximal coil wire end 130, since it is positioned further towards the proximal end (or mouth end) of the device. The second coil wire end 130 of the inductor coil 126 may be referred to as the distal coil wire end, since this end is positioned further towards the distal end of the device in use.

The coil wire end positioning arrangement 400 of the chassis 109 has a first positioning means 401 and a second positioning means 402. The first positioning means 401 may be provided in a position on the chassis that is further towards the proximal end of the device than the second positioning means 402 as shown in FIG. 13. The first positioning means 401 is configured to receive and hold in position the first, or proximal, end 130 of the inductor coil 124 in a first, proximal, position and the second positioning means 402 is configured to receive and hold in position the second, distal, end of the inductor coil 124 in a second, distal position, as shown in FIGS. 13 and 14.

In some examples, the first position and the second position are not axially aligned with each other, such as is shown with the first induction coil wire 124 in FIG. 15b. In other examples, the first position and the second position are axially aligned with each other, such as is shown with the first induction coil wire 124 in FIG. 16b. In the example wherein both ends of the same inductor coil wire 124 are axially aligned with each other, it is possible to provide a battery connector on the PCB such that the position of the battery connector is also axially aligned with the positions of both coil wire ends of the inductor coil 124. This provides the advantage that the layout of the PCB is simplified and further space is provided on the PCB for additional components.

In the examples shown in FIGS. 15a, 15b, 16a and 16b of the present application, the device also comprises a second inductor coil 126 that extends around the coil support and heater assembly 105. The second inductor coil 126 comprises wire that is also configured to generate the varying magnetic field. The second inductor coil 126 also has both a first, proximal, coil wire end 130 and a second, distal, coil wire end 130, each of which are engaged with the electrical component, e.g. PCB.

In such examples wherein two inductor coils 124, 126 are provided, the positioning arrangement 400 is further configured to receive, hold and align the first and second coil wire ends 130 of this second inductor coil 126 with the electrical component, e.g. PCB. In order to achieve this, the coil wire end positioning arrangement 400 has a third positioning means 403 that is configured to provide, and/or hold the first, or proximal, end of said second inductor coil 126 in a third position and a fourth positioning means 404 that is configured to provide and/or hold said second, or distal, end of said second inductor coil 126 in a fourth position.

A first arrangement of this type is shown in FIGS. 13, 14, 15a and 15b and a second arrangement of this type is shown in FIGS. 16a and 16b.

As discussed above and shown in these figures, the susceptor 132, the coil support 200, and the first and second inductor coils 124, 126 are coaxial around the central longitudinal axis 101 of the susceptor 132 and device 100. The first inductor coil 124 is adjacent to the second inductor coil 126 in a direction along the longitudinal axis 101 of the device 100 (that is, the first and second inductor coils 124, 126 do not overlap) as shown in FIGS. 15b and 16b. In other words, the distal, or second, coil wire end, of the first inductor coil wire 124 is adjacent to the proximal, or first, coil wire end of the second inductor coil wire 126, as shown in the figures.

The arrangement shown in FIGS. 13, 14, 15a and 15b will now be described. In this arrangement, the first and second positions of the first and second coil wire ends of the first inductor coil wire 124 (and in these examples also the first and second positioning means 401, 402 themselves) are not axially aligned with each other. In other words, the first and second positions are circumferentially offset from each other. In this example, this is achieved by the first positioning means 401 being provided on the chassis in a first position and the second positioning means 402 being provided on the chassis in a second position, wherein the first and second position are not axially aligned with each other.

In the same way, the first and second coil wire ends of the second inductor 126 are also not axially aligned with each other. In this example, this is achieved by the third positioning means 403 being provided on the chassis in a third position and the fourth positioning means 403 being provided on the chassis in a fourth position. As can be seen from FIGS. 13 and 14, the third and fourth position are not axially aligned with each other.

In this example, although the positions of the ends of each individual inductor coil 124, 126 are not axially aligned, the proximal ends of both inductor coils 124, 126 are axially aligned with each other and the distal ends of both inductor coils 126 are axially aligned with each other. That is, the proximal ends of both wires are provided in the first and third positions which are axially aligned with each other on a first axis and the distal ends of both inductor coil wires 124, 126 are provided in the second and fourth positions which are axially aligned with each other on a second axis which is different to the first axis. The first and second axis are parallel to the longitudinal axis 101 of the device. This arrangement provides an advantage in that it allows for a reduction of the width of the PCB.

The arrangement as shown in FIGS. 16a and 16b will now be described.

In this example, the wire positioning arrangement 400 is configured to hold the wire ends 130 so that all of the coil wire ends 130 are axially aligned with each other. That is, the first, second, third and fourth coil positions of the coil wire ends 130 are axially aligned with each other (i.e. they are not circumferentially offset from each other). This is shown in FIG. 16b. This may be achieved by providing a positioning arrangement 400 wherein a first, second, third and fourth positioning means 401, 402, 403, 404 are provided on the chassis in first, second, third and fourth positions, each of which are axially aligned with each other.

In this embodiment, the battery connector may also be positioned on the PCB so that is axially aligned with the first, second, third and fourth positions of the coil wire ends. This arrangement provides the advantage that, since all of the coil wire ends are positioned on the same axis as each other as well as the battery connector, the PCB layout is less complicated and provides additional space on the PCB. The positioning means, battery connector and coil wire ends of this arrangement may be provided along an axis that extends in a direction that is parallel to the longitudinal axis 101 of the device.

In the examples described herein, each of the positioning means 401, 402, 403, 404 are shown as comprising a protrusion, or alignment tab, that protrudes from the chassis 109. The alignment tab has a through-hole provided therethrough that is sized and shaped for receiving the coil wire end. Each alignment tab may extend inwardly from the chassis 109 and in a direction parallel to the electrical component, e.g. PCB as shown in FIG. 14. As also shown in FIG. 14 the through-hole may extend in a direction perpendicular to the PCB. This means that, in use, the wire coil end would extend through the through-hole and contact the underside of the PCB which is positioned above the chassis as shown in FIG. 1. Other types of wire positioning means may also be envisaged. The alignment tab is therefore configured to provide the coil wire end in the correct position and is also configured to hold it in that position in use.

A method of assembling the aerosol provision device described above may comprise positioning the aerosol generating assembly on the chassis 109, inserting each of the inductor coil ends into the respective positioning means 401, 402, 403, 404, so that they are respectively held in the first to fourth positions as described above, and connecting each of the coil ends 130 to an electrical component such as a PCB.

The above described arrangements provide an advantage in that they allow for different, improved, arrangements of electrical components connecting to coil wire ends of inductor coils.

The above embodiments are to be understood as illustrative examples of the invention. Further embodiments of the invention are envisaged. It is to be understood that any feature described in relation to any one embodiment may be used alone, or in combination with other features described, and may also be used in combination with one or more features of any other of the embodiments, or any combination of any other of the embodiments. Furthermore, equivalents and modifications not described above may also be employed without departing from the scope of the invention, which is defined in the accompanying claims.

1. An aerosol provision device, the device comprising:
an aerosol generating assembly;
an electrical component; and
a chassis holding the aerosol generating assembly and the electrical component;
the aerosol generating assembly having: a heater assembly configured to receive aerosol generating material, wherein the heater assembly comprises a susceptor which is heatable by penetration with a varying magnetic field; and an inductor coil extending around the heater assembly wherein the inductor coil is configured to generate the varying magnetic field;
wherein the inductor coil comprises a coil wire end engaged with the electrical component; and wherein the chassis comprises a coil wire end positioning arrangement configured to hold and align the coil wire end with respect to the electrical component.

2. The aerosol provision device of claim 1, wherein said coil wire end is a first end of the inductor coil, and the inductor coil comprises a second end, and wherein said coil wire end positioning arrangement has a first positioning means that is configured to provide said first end of said inductor coil in a first position and a second positioning means that is configured to provide said second end of said inductor coil in a second position.

3. The aerosol provision device of claim 1, wherein the inductor coil is a first inductor coil, the aerosol provision device comprising a second inductor coil extending around the coil support and wherein the second inductor coil comprises a second coil wire with first and second coil wire ends engaged with the electrical component, and, wherein the positioning arrangement is configured to hold and/or align the first and second coil wire ends of the second inductor coil with the electrical component.

4. The aerosol provision device of claim 3, wherein said coil wire end positioning arrangement has a third positioning means that is configured to provide said first end of said second inductor coil in a third position and a fourth positioning means that is configured to provide said second end of said second inductor coil in a fourth position.

5. The aerosol provision device of claim 2, wherein said first and second positions are not axially aligned with each other.

6. The aerosol provision device of claim 2, wherein said first and second positions are axially aligned with each other.

7. The aerosol provision device of claim 4,
wherein said third and fourth positions are not axially aligned with each other.

8. The aerosol provision device of claim 4, wherein said third and fourth positions are axially aligned with each other.

9. The aerosol provision device of claim 5, wherein said first and third positions are aligned with each other on a first axis and wherein said second and fourth positions are aligned with each other on a second axis.

10. The aerosol provision device of claim 4, wherein said first, second, third and fourth positions are axially aligned with each other.

11. The aerosol provision device of claim 10, further comprising a battery and a battery connector, said battery connector being configured to receive a cable to charge said battery of the device, and wherein said battery connector is positioned on said electrical component so that is axially aligned with said first, second, third and fourth positions.

12. The aerosol provision device of claim 2, wherein each of said positioning means comprises an alignment tab protruding from said chassis, said alignment tab having a through-hole provided therethrough sized and shaped for receiving said coil wire end.

13. The aerosol provision device of claim 12, wherein said alignment tab extends inwardly from said chassis and in a direction parallel to said electrical component.

14. The aerosol provision device of claim 12, wherein said through-hole extends in a direction perpendicular to the electrical component.

15. The aerosol provision device of claim 1, wherein said electrical component is a printed circuit board “PCB”.

16. A chassis for an aerosol provision device, the chassis comprising: an electrical component mount; an aerosol generating assembly mount, and an inductor coil wire end positioning arrangement configured to hold and align first and second wire ends of an inductor coil of an aerosol generating assembly mountable on the chassis with respect to an electrical component mountable on the chassis.

17. The chassis of claim 16, wherein said inductor coil wire end positioning arrangement has a first positioning means that is configured to provide said first inductor coil wire end in a first position and a second positioning means that is configured to provide said second inductor coil wire end in a second position.

18. The chassis of claim 17, said coil wire end positioning arrangement further comprising a third positioning means that is configured to provide a third inductor coil wire end of an inductor coil wire in a third position and a fourth inductor coil wire end of an inductor coil wire in a fourth position.

19. The chassis of claim 17, wherein said first and second positions are not axially aligned with each other.

20. The chassis of claim 17, wherein said first and second positions are axially aligned with each other.

21-29. (canceled)
